(19) United States
(12) Patent Application Publication
(10) Pub. No.: US 2003/0074282 A1
(43) Pub. Date: Apr. 17, 2003

(54) Inventory management system for effecting an efficient reply of possible future component parts from a component part supplier

(75) Inventor: Jen-Fu Lee, Taipei (TW)

Correspondence Address: BACON & THOMAS, PLLC, 625 SLATERS LANE, FOURTH FLOOR, ALEXANDRIA, VA, 22314

(73) Assignee: Inventec Corporation, Taipel (TW)

(21) Appl. No.: 09/974,885

(22) Filed: Oct. 12, 2001

(51) Int. Cl. G06F 17/60

(52) U.S. Cl. 705/28

(57) ABSTRACT

The invention is an inventory management system for effecting an efficient reply of possible future component parts from a component part supplier, which determines whether each component part supplier has replied a document within a specified forthcoming period of time after receiving the same by a computer system of the component part supplier. If yes, the replied document is stored in database. If not, the system may assume the estimated quantity of component parts as possible quantity of component parts supplied by component part supplier in the future and store the same in database.

### FIELD OF THE INVENTION

The present invention relates to an inventory management system, and more particularly to such an inventory management system for effecting an efficient reply of possible future component parts from a component part supplier.

### BACKGROUND OF THE INVENTION

Information technologies have known a rapid and a spectacular development in decades. And in turn competition has become even fierce in all fields. Also, an increasing use of telecommunications and the convenience of transportation have expanded global commerce and trade significantly. In view of this circumstance, almost all well known product manufacturers endeavor to research and analyze resources of manpower, capitals, technologies, and distribution in the world. Thereafter, it is possible of utilizing characteristics and advantages associated with various regions in the world for establishing branches of research and development, manufacturing, and trade therein. In one aspect, the research and development branch can tailor the needs of local market to design appropriate products. Further, the manufacturing branch may manufacture the same. Finally, the manufactured products may be delivered to the consumers through associated distributors in the world. This process can significantly reduce cost and delivery time as well as enhance competition.

As stated above, almost all well known product manufacturers endeavor to integrate their design, development, manufacturing, and marketing in their global strategy. Further, the research and development branch is required to tailor the needs of local market to design appropriate products. Finally, the manufactured products may be quickly delivered to the consumers through associated distributors in the world. As to the product manufacturers, they have to increase information communication efficiency thereof so as to cooperate with associated manufacturers. Also, the communication should be efficient and accurate. With this, it is possible of truly reflecting markets, quickly delivering goods, and minimizing inventory. As a result, the purposes of attracting consumers with such products and being competitive in the markets are obtained.

In general, an inventory management system is established between a downstream product manufacturer and an upstream component part supplier (or manufacturer) for estimating quantity of component parts demanded by product manufacturer in a near future. Preferably, inventory is a minimum. Such system is best illustrated in FIG. 1 wherein a network connection 30 interconnects a computer system in product manufacturer 10 and a computer system in component part supplier (or manufacturer) 20. Product manufacturer 10 may estimate quantity of component parts demanded in a forthcoming period of time. Also, component part supplier (or manufacturer) 20 may be informed of such estimation by product manufacturer 10 via network connection 30. Moreover, component part supplier (or manufacturer) 20 is required to estimate possible quantity of supplied component parts based on inventory and production thereof during the specified period of time. In addition, component part supplier (or manufacturer) 20 has to reply product manufacturer 10 about the estimation immediately. Hence, product manufacturer 10 may estimate the production thereof during the forthcoming period of time. The estimation is in turn used as a basis for accepting orders from buyers. Thus, component part supplier (or manufacturer) 20 also knows how to effectively utilize production line to tailor the needs. As a result, optimum quantities of component parts are manufactured, resulting in a reduction in the inventory cost.

A detail configuration of above system is shown in FIG. 2 wherein estimated quantity of component parts demanded by product manufacturer 10 in a forthcoming period of time are written into a document 11 prior to informing component part supplier (or manufacturer) 20 via network connection 30. Then component part supplier (or manufacturer) 20 is required to estimate possible quantity of supplied component parts based on inventory and production during the specified period of time. In addition, component part supplier (or manufacturer) 20 has to reply product manufacturer 10 with a document 11 about the estimation immediately. However, component part supplier (or manufacturer) 20 usually does not reply within a period of time required by product manufacturer 10. Moreover, data contained in the replied document 11 may be incorrectly inputted. As a result, there is an inconsistency (sometimes significant) between product manufacturer 10 and each component part supplier (or manufacturer) 20 with respect to estimated quantity of component parts capable of being supplied from component part suppliers (or manufacturers) 20. Such inconsistency may adversely affect the actual production by product manufacturer 10. In response, product manufacturer 10 may usually require system administrators to check information of the inventory management system manually. This brings inconvenience to product manufacturer 10.

Thus, it is desirable to provide an improved inventory management system in order to overcome the above drawbacks of prior art.

### SUMMARY OF THE INVENTION

It is therefore an object of the present invention to provide an inventory management system for effecting an efficient reply of possible future component parts from one of a plurality of component part suppliers, wherein a network connection is utilized by the inventory management system for interconnecting a product manufacturer and the component part suppliers. The system may estimate possible quantity of supplied component parts from component part supplier based on spare part records of component part suppliers stored in a database thereof. The estimated result is written into a document wherein quantity, description, and proportion of component parts supplied by component part supplier are listed in fields of document. Such component parts are necessary for manufacturing goods by product manufacturer in a forthcoming period of time. Then component part suppliers are informed of the proportional quantity of component parts listed in document through network connection for confirmation. By utilizing this inventory management system, inventory of component parts owned by component part supplier may be maintained in an optimum.

In one aspect of the present invention, the inventory management system determines whether each component part supplier has replied a document within a specified forthcoming period of time after receiving the same by a computer system of the component part supplier. If yes, the replied document is stored in database. If not, the system may assume the estimated quantity of component parts as possible quantity of component parts supplied by component part supplier in the future and store the same in database. This can cause component part supplier to quickly access its capability of supplying required quantity of component parts in the specified period of time. As a result, an efficient reply from component part supplier is realized. Further, input errors are significantly reduced. Hence, estimated quantities of component part supplied from component part suppliers are about equal to actual ones.

The above and other objects, features and advantages of the present invention will become apparent from the following detailed description taken with the accompanying drawings.

### BRIEF DESCRIPTION OF THE DRAWINGS

FIG. 1 is a schematic diagram of a conventional inventory management system;

FIG. 2 is a detailed block diagram of FIG. 1

FIG. 3 is a block diagram of a preferred embodiment of inventory management system according to the invention; and

FIG. 4 is a flow chart of the preferred embodiment of inventory management system according to the invention.

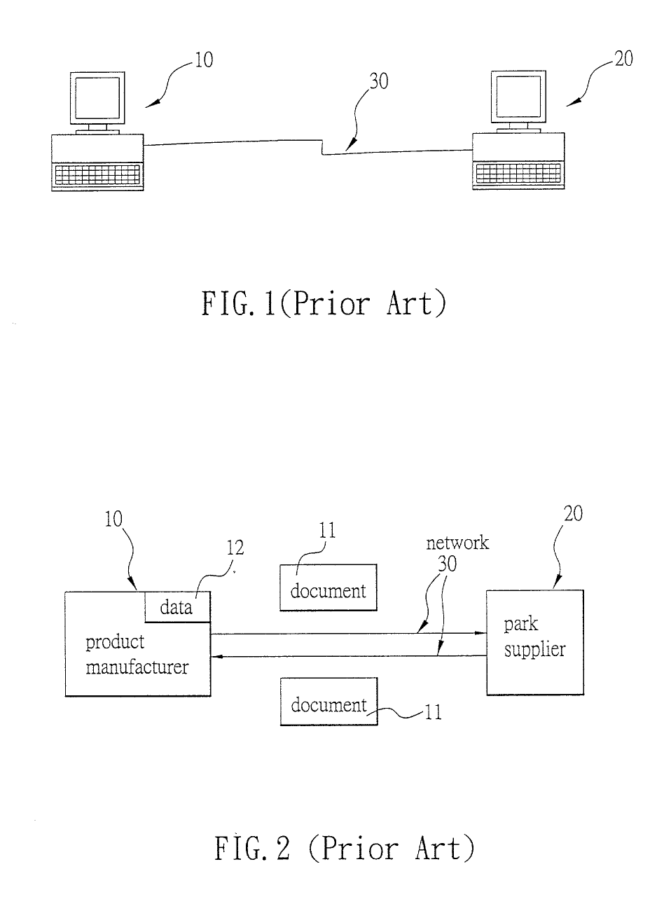

### DETAILED DESCRIPTION OF THE PREFERRED EMBODIMENTS

The invention is directed to an inventory management system for effecting an efficient reply of possible future component parts from one of a plurality of component part suppliers wherein a network connection is utilized by inventory management system for interconnecting product manufacturer and component part suppliers, so that product manufacturer may know a correct inventory of component part supplier (or manufacturer) as a basis for accepting orders from buyers, and component part supplier may know how to effectively utilize production line to tailor the needs. As a result, optimum quantities of component parts are manufactured, resulting in a reduction in the inventory cost.

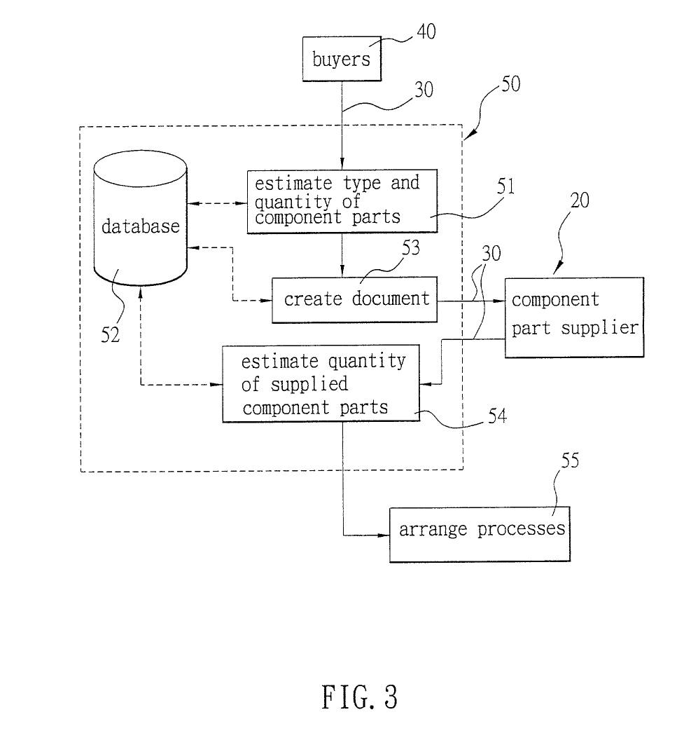

FIG. 3 is a block diagram of a preferred embodiment of inventory management system according to the invention. Network connection 30 is utilized by inventory management system 50 for receiving orders from buyers 40. Then system 50 estimates types and quantity of component parts 51 required for manufacturing goods listed in the orders. Such estimation is stored in a database 52. Then system 50 may estimate possible quantity of supplied component parts from component part supplier 20 based on spare part records of component part supplier stored in database 52. The estimated result is written into a document 53 wherein types, quantity, and description of component part supplied by component part supplier are listed in fields of document 53. Such component parts are necessary for manufacturing goods by product manufacturer in a forthcoming period of time. Then computers of component part suppliers are individually informed of inputting quantity of component parts 54 capable of being supplied therefrom in documents 53 in the specified period of time via network connection 30. The filled documents 53 are required to send back to computer of product manufacturer immediately. Hence, product manufacturer may arrange manufacturing processes 55 based on data contained in documents 53.

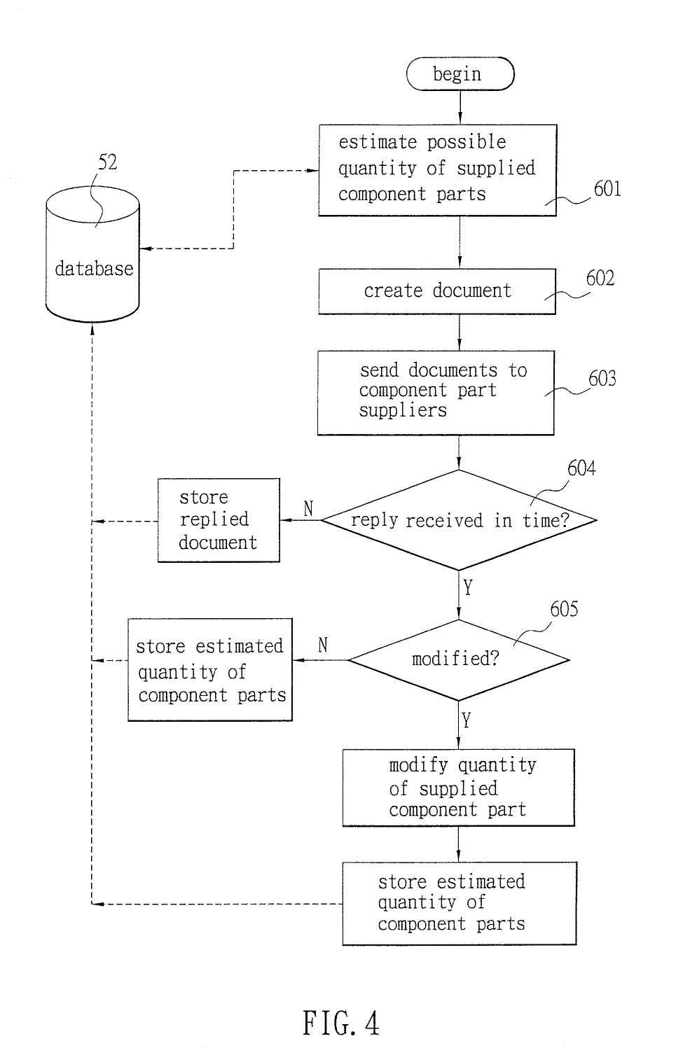

Referring to FIG. 4, there is shown a flow chart of a preferred embodiment of inventory management system according to the invention. As mentioned above, prior art suffered from a number of disadvantages, i.e., component part supplier has to send system administrators to check inventory manually. This can cause a delay of inputting quantity of component parts in document by component part supplier in the specified period of time. Hence, component part supplier cannot reply in time. Moreover, data contained in the replied document may be incorrectly inputted. As a result, there is an inconsistency (sometimes it is significant) between product manufacturer and each component part supplier with respect to estimated quantity of component parts capable of being supplied from component part suppliers. For eliminating these, a management mechanism is provided in inventory management system capable of estimating possible quantity of supplied component parts from component part suppliers based on past records. The mechanism comprises the following steps:

In step 601, inventory management system may estimate possible quantity of supplied component parts from component part supplier in a forthcoming period of time based on spare part records of component part supplier (monthly, yearly, or average) stored in database 52 of the system. Then the estimation is written into documents which are in turn sent to component part suppliers individually.

In step 602, arrange the estimated quantity of component parts proportionally and writing the same in each field of document for completing the document.

In step 603, component part suppliers are informed of the proportional quantity of component parts listed in document through network connection for confirmation. Hence, component part supplier may quickly access its capability of supplying such quantity of component parts. As a result, an efficient reply from component part supplier is realized. It is contemplated that component part supplier may modify the proportion of quantity of component parts in the document directly prior to reply, if such proportion is not achievable in that forthcoming period of time.

In step 604, the system determines whether document from each component part supplier has been received within the specified period of time. If yes, the replied document is stored in database 52. If not, the process jumps to step 605.

In step 605, the system may assume the estimated quantity of component parts as possible quantity of component parts supplied by component part supplier in the future and store the same in database 52, if there is no reply from component part supplier to product manufacturer within the period of time after component part supplier has received document from the system. If system administrator of component part supplier has questions about the proportional quantity of component parts. The system administrator may modify the proportion after inquiring component part supplier. The modified proportion of quantity of component parts is stored in database 52.

In brief, the inventory management system of the invention can cause component part supplier to quickly access its capability of supplying required quantity of component parts in a specified forthcoming period of time. As a result, an efficient reply from component part supplier is realized. Further, input errors are significantly reduced. Hence, estimated quantities of component part supplied from component part suppliers are about equal to actual ones. As a result, a well managed database is realized.

While the invention has been described by means of specific embodiments, numerous modifications and variations could be made thereto by those skilled in the art without departing from the scope and spirit of the invention set forth in the claims.

What is claimed is:

1. In an inventory management system having a database and a network connection interconnected a product manufacturer and at least one component part supplier, a process comprising the steps of:
estimating possible quantity of component parts supplied from the component part supplier based on spare part records of the component part supplier stored in the database;
writing the estimation into one of a plurality of documents wherein a quantity, a description, and a proportion of the component parts of a product required in a forthcoming period of time are listed in fields of the document; and
informing the component part supplier of the proportion of the component parts listed in the document through the network connection for confirmation.

2. The process of claim 1, wherein the spare part records of the component part supplier are recorded monthly.

3. The process of claim 1, wherein the spare part records of the component part supplier are recorded yearly.

4. The process of claim 1, wherein the spare part records of the component part supplier are recorded in an average.

5. The process of claim 1, wherein the component part supplier is allowed to modify the estimated proportion of the component parts in the fields of the document directly, if the proportion is not achievable in the forthcoming period of time.

6. The process of claim 1, wherein the system determines whether the component part supplier has replied the document to a computer of the product manufacture within a predetermined period of time after receiving the same by a computer system of the component part supplier, and the system stores the replied document in the database if the determination is positive.

7. The process of claim 6, wherein if the determination is negative, the system takes the estimated quantity of the component parts as a possible quantity of the component parts supplied by the component part supplier in the forthcoming period of time and store the same in the database.
